(19) United States
(12) Patent Application Publication
(10) Pub. No.: US 2015/0143317 A1
(43) Pub. Date: May 21, 2015

(54) Determination Of Electromigration Features

(71) Applicant: Mentor Graphics Corporation, Wilsonville, OR (US)

(72) Inventors: Patrick Gibson, Wilsonville, OR (US); Sridhar Srinivasan, Wilsonville, OR (US); William Matthew Hogan, Wilsonville, OR (US)

(73) Assignee: Mentor Graphics Corporation, Wilsonville, OR (US)

(21) Appl. No.: 14/085,788

(22) Filed: Nov. 20, 2013

(51) Int. Cl. G06F 17/50

(52) U.S. Cl. CPC G06F 17/5081; G06F 2217/82; G06F 2217/12
USPC 716/115

(57) ABSTRACT

For one or more geometric elements partitioned into a plurality of geometric element portions, the expected current directions through each geometric element portion are determined. Using the expected current directions, each expected current path through the geometric element portions is determined. Based upon the expected current paths, and the physical characteristics represented by the geometric element portions in those expected current paths, the electromigration features corresponding to the geometric element or elements are determined. For example, the length of the longest expected current path through the geometric element or elements can be identified based upon the lengths of the geometric element portions and the directions of their currents, and this length can then be compared with the Blech length for the geometric element or elements.

### FIELD OF THE INVENTION

The present invention is directed to the determination of electromigration features corresponding with layout design data. Various implementations of the invention may be useful for determining when geometric elements in layout design data will provide undesirable electromigration features in an electronic circuit manufactured from the layout design data.

### BACKGROUND OF THE INVENTION

Electronic circuits, such as integrated microcircuits, are used in a variety of products, from automobiles to microwave ovens to personal computers. Designing and fabricating microcircuit devices typically involves many steps, known as a “design flow.” The particular steps of a design flow often are dependent upon the type of microcircuit being designed, its complexity, the design team, and the microcircuit fabricator or foundry that will manufacture the microcircuit. Typically, software and hardware “tools” will verify a design at various stages of the design flow by running software simulators and/or hardware emulators, and errors in the design are corrected.

Several steps are common to most design flows for digital mircocircuit devices. Initially, the specification for the new microcircuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logical of the circuit is then analyzed, to confirm that the logic incorporated into the design will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This logical generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the functions desired for the circuit. This analysis is sometimes referred to as “formal verification.”

Once the relationships between circuit devices have been established, the design is again transformed, this time into a physical design that describes specific geometric elements. This type of design often is referred to as a “layout” design. The geometric elements define the shapes that will be created in various materials to actually manufacture the circuit device components (e.g., contacts, gates, etc.) making up the circuit. While the geometric elements are typically polygons, other shapes, such as circular and elliptical shapes, also may be employed. These geometric elements may be custom designed, selected from a library of previously-created designs, or some combination of both. Geometric elements also are added to form the connection lines that will interconnect these circuit devices.

With a layout design, each physical layer of the microcircuit will have a corresponding layer representation, and the geometric elements described in a layer representation will define the relative locations of the circuit device components that will make up a circuit device. Thus, the geometric elements in the representation of an implant layer will define the regions where doped material will be located, while the geometric elements in the representation of a metal layer will define the locations where conductive wires will be formed to connect the circuit devices. Typically, a designer will perform a number of analyses on the layout design. For example, the layout design may be analyzed to confirm that it accurately represents the circuit devices and their relationships described in the device design. The layout design also may be analyzed to confirm that it complies with various design requirements, such as minimum spacings between geometric elements. Still further, it may be modified to include the use of redundant or other compensatory geometric elements intended to counteract limitations in the manufacturing process, etc.

After the layout design has been finalized, then it is converted into a format that can be employed by a mask or reticle writing tool to create a mask or reticle for use in a photolithographic manufacturing process. Examples of such formats are MEBES, for raster scanning machines manufactured by ETEC, an Applied Materials Company, the “.MIC” format from Micronics AB in Sweden, and various vector scan formats for Nuflare, JEOL, and Hitachi machines, such as VSB12 or VSB12. The written masks or reticles can then be used in a photolithographic process to expose selected areas of a wafer in order to produce the desired integrated circuit devices on the wafer.

One issue in particular that occurs with both digital and analog integrated circuits is electromigration. Electromigration is the gradual displacement of material caused by the movement of the ions in a material due to the momentum transfer between conducting electrons traveling through the material and diffusing metal atoms. That is, electromigration is the breakdown of material over time caused by an electron “wind” traveling in a constant current direction through the material and pushing against atoms in the material. Conductive material, such as the copper or aluminum metal used for integrated circuit interconnects, is particularly vulnerable to electromigration, and the effects of electromigration can reduce the reliability of integrated circuit.

The operation of electromigration is well known, and various electronic design automation (EDA) tools have been developed to assist designers in avoiding integrated circuit designs that will produce integrated circuits susceptible to electromigration. Conventional detection of interconnects at risk from electromigration uses techniques akin to finite element analysis, but these techniques are extremely resource intensive. Alternate approaches determine the expected current density for an interconnect in a design (e.g., the current density that will be expected in the corresponding physical interconnect manufactured from the design). These techniques, however, typically determine whether the expected current density will cause the physical interconnect to fail quickly with use. They do not determine whether or not the physical interconnect will degrade over longer periods of time due to electromigration, or at what rate the degradation will occur.

### BRIEF SUMMARY OF THE INVENTION

Aspects of the invention relate to techniques for determining the electromigration features corresponding to layout design data. As will be discussed in detail below, embodiments of both tools and methods implementing these techniques have particular application for analyzing layout design data to determine if electromigration will occur in a circuit, and, with various implementations of the invention, the extent of such electromigration.

According to various examples of the invention, one or more geometric elements in layout design data are partitioned into portions. As will be explained in more detail below, the geometric element or elements represent a circuit structure in an electrical device that may be susceptible to electromigration. Typically, the circuit structure will have only one component represented by only a single geometric element, such as an interconnect. In some cases, however, the circuit structure will have multiple components represented by multiple geometric elements, such as an interconnect connected to a metal resistor or inductor, or two interconnects connected with a via that allows for electromigration. Typically, each geometric element is a polygon having a “Manhattan” shape (i.e., having only right angles, which can be convex or concave). With various implementations of the invention, each geometric element is divided up into rectangles and squares, where square portions are formed between opposing convex and concave angles.

Next, the expected conventional current directions through each geometric element portion are determined. That is, the current directions that would be expected in an integrated circuit structure manufactured from the geometric element or elements are determined. With various implementations of the invention, the expected current directions may be determined by treating the partition boundary of each geometric element portion as a node in a circuit, and then employing a matrix solver to determine expected voltage differences between adjacent boundaries for a given circuit input. If an expected voltage at a boundary on a first side of a geometric element portion is higher than the expected voltage for a boundary on a second side of the geometric element portion, then the expected conventional current direction can be determined to be from the first side to the second side. (As will be appreciated by those of ordinary skill in the art, the term current direction as used herein is the conventional current direction, that is, the flow of positive charges through a geometric element portion, while the flow of electrons will be in the opposite direction.)

Once the expected current directions have been determined for each geometric element portion, each expected current path through the geometric element portions is determined. That is, each possible current path that would be expected in an integrated circuit structure manufactured from the geometric element or elements is determined. Based upon the expected current paths, and the physical characteristics represented by the geometric element portions in those expected current paths, the electromigration features corresponding to the geometric element or elements are determined. For example, the length of the longest expected current path through the geometric element or elements can be identified based upon the lengths of the geometric element portions and the directions of their currents. This length can then be compared with the Blech length for the geometric element or elements. If the length of the longest expected current path does not exceed the Blech length, then the designer will know that the circuit structure formed from the geometric element or elements will not be susceptible to electromigration. On the other hand, if the length of the longest expected current path does exceed the Blech length, then the designer may be able to employ the amount that the length of the expected path exceeds the Blech length to predict how the manufactured circuit structure will be degraded by electromigration over time.

These and other features and aspects of the invention will be apparent upon consideration of the following detailed description.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 schematically illustrates an example of a family of software tools for automatic design automation that may employ associative properties according to various embodiments of the invention.

FIG. 4 illustrates a tool for determining electromigration features corresponding with layout design data according to various embodiments of the invention.

FIGS. 5A and 5B illustrate a flowchart showing a process for determining electromigration features corresponding to layout design data that may be implemented according to various examples of the invention.

FIG. 6 illustrates a net made up of a geometric element on a first metal layer, a geometric element on a second metal layer, a geometric element on a third metal layer, and a geometric element on a fourth metal layer.

FIG. 7A illustrates a geometric element divided into portions.

FIG. 7B illustrates the geometric element of FIG. 7A showing current directions through the portions.

FIG. 8A illustrates an undirected cyclic graph representing the portions of the geometric element shown in FIG. 7A.

FIG. 8B illustrates a directed graph representing the currently directions through the portions of the geometric element shown in FIG. 7B.

### DETAILED DESCRIPTION OF THE INVENTION

### Illustrative Operating Environment

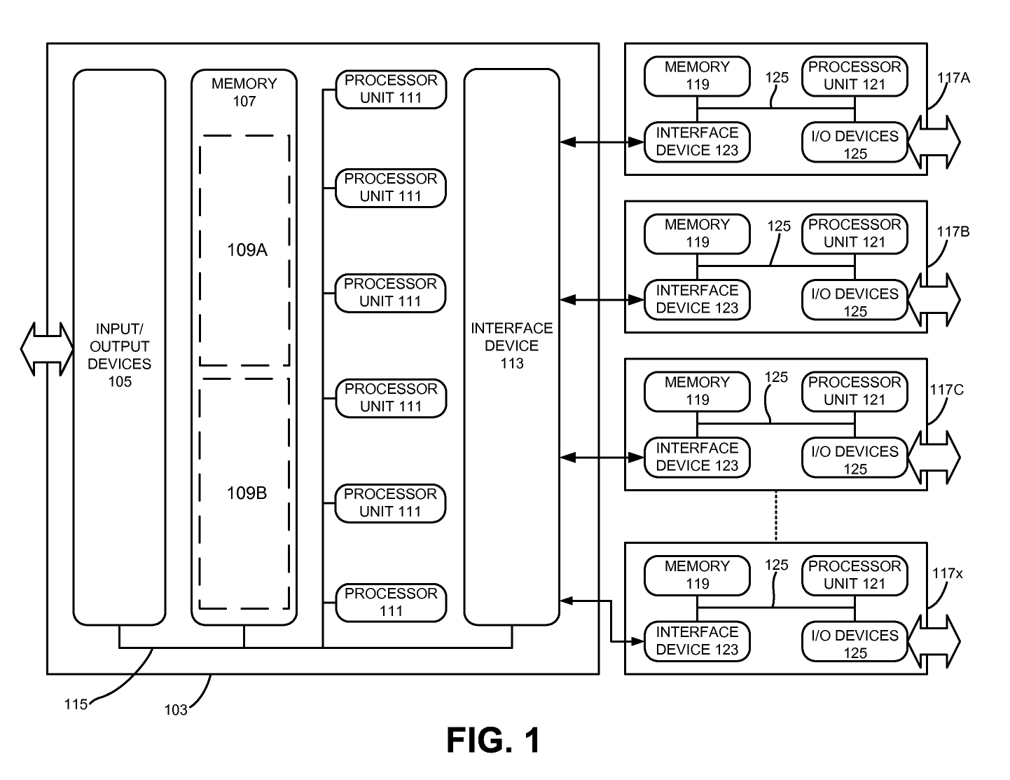

The execution of various electronic design automation processes according to embodiments of the invention may be implemented by one or more programmable computing devices executing computer software instructions, by the storage of computer-executable software instructions on a non-transitory storage device, or some combination of both. Accordingly, the components and operation of a generic programmable computer system through which various embodiments of the invention may be implemented will first be described. Further, because of the complexity of some electronic design automation processes and the large size of many circuit designs, various embodiments of the invention may be implemented through a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable storage devices that can be accessed by the master computer 103. The computer readable storage device may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable storage device may also include magnetic cassettes, magnetic tapes, magnetic disks or other magnetic storage devices, punched media, holographic storage devices, or any other non-transitory storage medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations, such as operations for implementing various embodiments of the invention. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

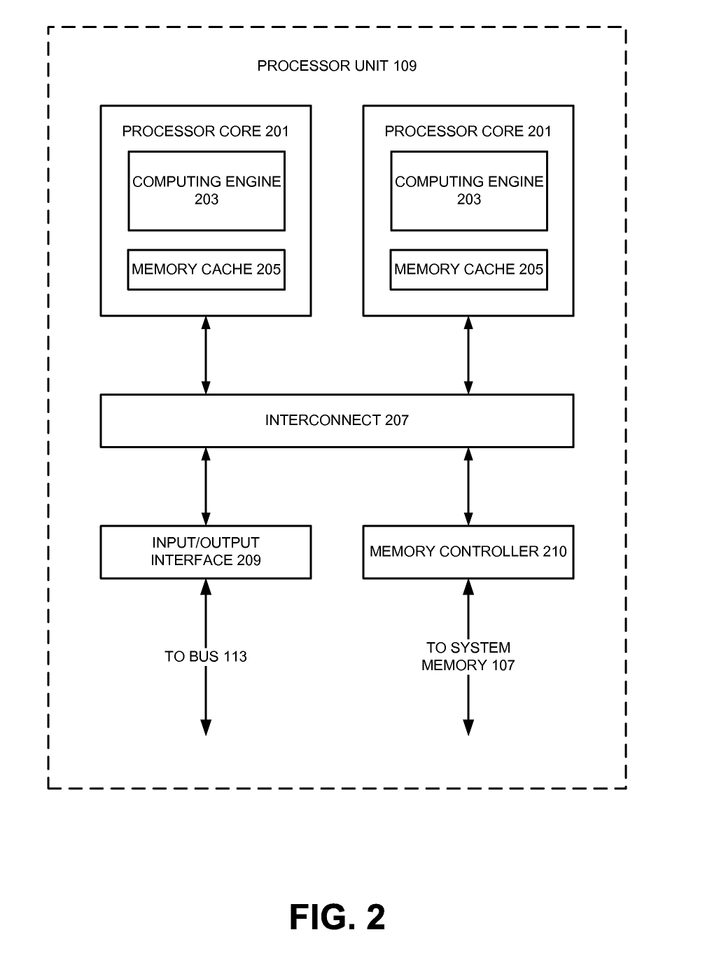

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. The memory 119 then may be implemented using any combination of the computer readable storage device discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Electronic Design Automation

As previously noted, various embodiments of the invention are related to electronic design automation. In particular, various implementations of the invention may be used to improve the operation of electronic design automation software tools that identify, verify and/or modify design data for manufacturing a microdevice, such as a microcircuit. As used herein, the terms “design” and “design data” are intended to encompass data describing an entire integrated circuit device. This term also is intended to encompass a smaller set of data describing one or more components of an entire integrated circuit device, however, such as a layer of an integrated circuit device, or even a portion of a layer of an integrated circuit device. Still further, the terms “design” and “design data” also are intended to encompass data describing more than one integrated circuit device, such as data to be used to create a mask or reticle for simultaneously forming multiple integrated circuit devices on a single wafer.

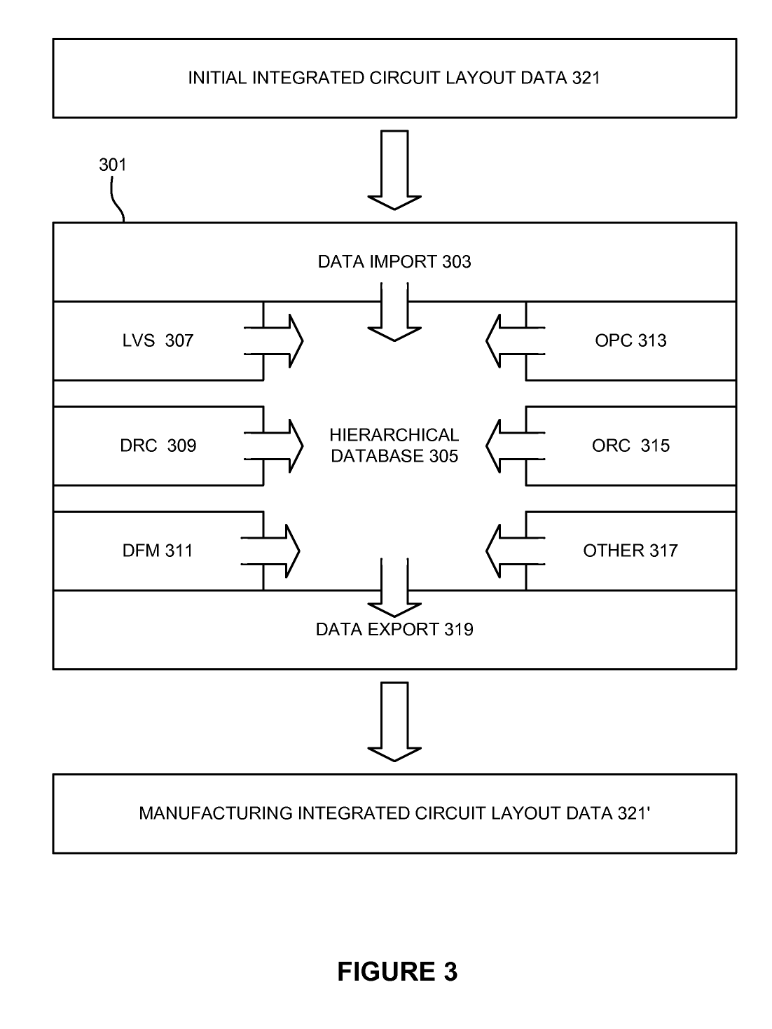

To facilitate an understanding of various embodiments of the invention, one such software tool for automatic design automation, directed to the analysis and modification of a design for an integrated circuit, will now be generally described. As seen in FIG. 3, an analysis tool 301, which may be implemented using a variety of different software applications, includes a data import module 303 and a hierarchical database 305. The analysis tool 301 also includes a layout-versus-schematic (LVS) verification module 307, a design rule check (DRC) module 309, a design-for-manufacturing (DFM) module 311, an optical proximity correction (OPC) module 313, and an optical proximity rule check (ORC) module 315. The analysis tool 301 may further include other modules 317 for performing additional functions as desired, such as a phase shift mask (PSM) module (not shown), an etch simulation analysis module (not shown) and/or a planarization simulation analysis module (not shown). The tool 301 also has a data export module 319. One example of such an analysis tool is the Calibre® family of software applications available from Mentor Graphics® Corporation of Wilsonville, Oreg.

Initially, the tool 301 receives data 321 describing a physical layout design for an integrated circuit. The layout design data 321 may be in any desired format, such as, for example, the Graphic Data System II (GDSII) data format or the Open Artwork System Interchange Standard (OASIS) data format proposed by Semiconductor Equipment and Materials International (SEMI). Other formats for the data 321 may include an open source format named Open Access, Milkyway by Synopsys, Inc., and EDDM by Mentor Graphics, Inc. The layout data 321 includes geometric elements for manufacturing one or more portions of an integrated circuit device. For example, the initial integrated circuit layout data 321 may include a first set of polygons for creating a photolithographic mask that in turn will be used to form an isolation region of a transistor, a second set of polygons for creating a photolithographic mask that in turn will be used to form a contact electrode for the transistor, and a third set of polygons for creating a photolithographic mask that in turn will be used to form an interconnection line to the contact electrode. The initial integrated circuit layout data 321 may be converted by the data import module 303 into a format that can be more efficiently processed by the remaining components of the tool 301.

Once the data import module 303 has converted the original integrated circuit layout data 321 to the appropriate format, the layout data 321 is stored in the hierarchical database 305 for use by the various operations executed by the modules 305-317. Next, the layout-versus-schematic module 307 checks the layout design data 321 in a layout-versus-schematic process, to verify that it matches the original design specifications for the desired integrated circuit. If discrepancies between the layout design data 321 and the logical design for the integrated circuit are identified, then the layout design data 321 may be revised to address one or more of these discrepancies. Thus, the layout-versus-schematic process performed by the layout-versus-schematic module 307 may lead to a new version of the layout design data with revisions. According to various implementations of the invention tool 301, the layout data 321 may be manually revised by a user, automatically revised by the layout-versus-schematic module 307, or some combination thereof.

Next, the design rule check module 309 confirms that the verified layout data 321 complies with defined geometric design rules. If portions of the layout data 321 do not adhere to or otherwise violate the design rules, then the layout data 321 may be modified to ensure that one or more of these portions complies with the design rules. The design rule check process performed by the design rule check module 309 thus also may lead to a new version of the layout design data with various revisions. Again, with various implementations of the invention tool 301, the layout data 321 may be manually modified by a user, automatically modified by the design rule check module 309, or some combination thereof.

The modified layout data 321 is then processed by the design for manufacturing module 311. As previously noted, a “design-for-manufacture” processes attempts to identify elements in a design representing structures with a significant likelihood of being improperly formed during the manufacturing process. A “design-for-manufacture” process may additionally determine what impact the improper formation of the identified structures will have on the yield of devices manufactured from the circuit design, and/or modifications that will reduce the likelihood that the identified structures may be improperly formed during the manufacturing process. For example, a “design-for-manufacture” (DFM) software tool may identify wires that are connected by single vias, determine the yield impact based upon the probability that each individual single via will be improperly formed during the manufacturing process, and then identify areas where redundant visa can be formed to supplement the single vias.

The processed layout data 321 is then passed to the optical proximity correction module 313, which corrects the layout data 321 for manufacturing distortions that would otherwise occur during the lithographic patterning. For example, the optical proximity correction module 313 may correct for image distortions, optical proximity effects, photoresist kinetic effects, and etch loading distortions. The layout data 321 modified by the optical proximity correction module 313 then is provided to the optical process rule check module 315

The optical process rule check module 315 (more commonly called the optical rules check module or ORC module) ensures that the changes made by the optical proximity correction module 313 are actually manufacturable, a “downstream-looking” step for layout verification. This compliments the “upstream-looking” step of the LVS performed by the LVS module 307 and the self-consistency check of the DRC process performed by the DRC module 309, adding symmetry to the verification step. Thus, each of the processes performed by the design for manufacturing process 311, the optical proximity correction module 313, and the optical process rule check module 315 may lead to a new version of the layout design data with various revisions.

As previously noted, other modules 317 may be employed to perform alternate or additional manipulations of the layout data 321, as desired. One such tool is a parasitic extraction tool, such as the Calibre® xRC™ parasitic extraction tool available from Mentor Graphics® Corporation of Wilsonville, Oreg. This parasitic extraction tool can be employed to precisely determine the expected electrical characteristics corresponding to geometric elements in layout design data, such as their expected resistance, expected inductance, and their expected capacitance. Accordingly, this tool is configured to partition geometric elements into portions, in order to precisely analyze the physical characteristics represented by the geometric elements. Further, it is configured to perform operations on the physical characteristics of those portions, such as the portion widths, the portion lengths, the physical properties of the materials represented by the geometric elements, etc.

After all of the desired operations have been performed on the initial layout data 321, the data export module 319 converts the processed layout data 321 into manufacturing integrated circuit layout data 323 that can be used to form one or more masks or reticules to manufacture the integrated circuit (that is, the data export module 319 converts the processed layout data 321 into a format that can be used in a photolithographic manufacturing process). Masks and reticles typically are made using tools that expose a blank reticle or mask substrate to an electron or laser beam (or to an array of electron beams or laser beams), but most mask writing tools are able to only “write” certain kinds of polygons, however, such as right triangles, rectangles or other trapezoids. Moreover, the sizes of the polygons are limited physically by the maximum beam (or beam array) size available to the tool.

Accordingly, the data export module 319 may “fracture” larger geometric elements in the layout design, or geometric elements that are not right triangles, rectangles or trapezoids (which typically are a majority of the geometric elements in a layout design) into the smaller, more basic polygons that can be written by the mask or reticle writing tool. Of course, the data export module 319 may alternately or additionally convert the processed layout data 321 into any desired type of data, such as data for use in a synthesis process (e.g., for creating an entry for a circuit library), data for use in a place-and-route process, data for use in calculating parasitic effects, etc. Further, the tool 301 may store one or more versions of the layout 321 containing different modifications, so that a designer can undo undesirable modifications. For example, the hierarchical database 305 may store alternate versions of the layout data 321 created during any step of the process flow between the modules 307-317.

### Data Organization

With various examples of the invention, layout design data may include two different types of data: “drawn layer” design data and “derived layer” design data. The drawn layer data describes geometric elements that will be used to form structures in layers of material to produce the integrated circuit. The drawn layer data will include geometric elements (usually polygons) that will be used to form structures in metal layers, diffusion layers, and polysilicon layers. The derived layers will then include features made up of combinations of drawn layer data and other derived layer data. Thus, with a transistor gate, derived layer design data describing the gate may be derived from the intersection of a geometric element in the polysilicon material layer and a geometric element in the diffusion material layer.

For example, a design rule check process performed by the design rule check module 309 typically will perform two types of operations: “check” operations that confirm whether design data values comply with specified parameters, and “derivation” operations that create derived layer data. A transistor gate design data thus may be created by the following derivation operation:

gate=diff AND poly

The results of this operation will be a “layer” of data identifying all intersections of diffusion layer geometric elements with polysilicon layer geometric elements. Likewise, a p-type transistor gate, formed by doping the diffusion layer with n-type material, is identified by the following derivation operation:

pgate=nwell AND gate

The results of this operation then will be another “layer” of data identifying all transistor gates (i.e., intersections of diffusion layer geometric elements with polysilicon layer geometric elements) where the geometric elements in the diffusion layer have been doped with n-type material.

A check operation performed by the design rule check module 309 will then define a parameter or a parameter range for a data design value. For example, a user may want to ensure that no metal wiring line is within a micron of another wiring line. This type of analysis may be performed by the following check operation:

external metal<1

The results of this operation will identify each geometric element in the metal layer design data that are closer than one micron to another geometric element in the metal layer design data.

Also, while the above operation employs drawn layer data, check operations may be performed on derived layer data as well. For example, if a user wanted to confirm that no transistor gate is located within one micron of another gate, the design rule check process might include the following check operation:

external gate<1

The results of this operation will identify all gate design data representing gates that are positioned less than one micron from another gate. It should be appreciated, however, that this check operation cannot be performed until a derivation operation identifying the gates from the drawn layer design data has been performed.

### Electromigration Features

Electromigration is a well-studied phenomenon that can occur in materials, particularly conductive materials. Electromigration is the gradual displacement of material caused by the movement of the ions in the material due to the momentum transfer between conducting electrons traveling through the material and diffusing atoms. As previously noted, conductive materials, such as the copper or aluminum metal used to form integrated circuit interconnects, are particularly vulnerable to electromigration. Accordingly, the effects of electromigration can reduce the reliability of integrated circuits. Many integrated circuit designers and manufacturers would therefore like to determine the expected effects of electromigration for an integrated circuit design before the design is employed to manufacture an integrated circuit. If it can be determined that a particular design feature will create undesirable electromigration effects in the resulting manufactured circuit, then the design can be modified to reduce or avoid those effects.

Features that will impact the susceptibility of a current path to electromigration are the widths of the current path. Where a portion of a current path is sufficiently wide relative to the current it carries, that portion of the current path will not be susceptible to failure from electromigration. Likewise, where a current path is sufficiently narrow, that portion of the current path will not be susceptible to failure from electromigration. The grain sizing of the material in the current path is another feature that influences the impact of electromigration on the path. Smaller grains produce more grain boundaries and a higher susceptibility to electromigration. If the current path width falls below the average grain size of the wire material, however, then the grain boundaries become perpendicular to the length of the wire. This “bamboo” effect reduces the impact of electromigration, likewise reducing the susceptibility of that portion of the current path to failure from electromigration despite an increase in current density.

Another feature that will impact the susceptibility of a “strongly connected” current path to electromigration is the length of that current path to a Blech length. As known to those of ordinary skill in the art, the Blech length is the lower limit for the length of a wire that will allow electromigration to occur. Any wire that has a length less than the Blech length is unlikely to fail from electromigration. As used herein, the term “strongly connected” refers to a current path having a length susceptible to cumulative electromigration effects. A strongly connected current path thus may be formed of two or more different structures that are electrically connected.

For example, an integrated circuit may have an interconnect in a metal layer connected to a metal resistor formed in the same metal layer. While the interconnect and the resistor may be represented as two different structures in layout design data, a single current path through both the interconnect and the resistor may be susceptible to cumulative electromigration effects, making the interconnect and the resistor strongly connected. Likewise, an integrated circuit may have two conductive copper interconnects on separate layers. If the interconnects are connected through a conventional copper via, then the two interconnects are not strongly connected. Conventional copper vias are formed with a surrounding jacket that restricts or prevents electromigration within the via itself. Thus, while the first and second copper interconnects are electrically connected, electromigration occurring in the second copper interconnect is not cumulative to electromigration occurring in the first copper interconnect; the length of each interconnect must be separately compared to the appropriate Blech length to determine if that interconnect is susceptible to failure from electromigration. If, however, the interconnects are connected through a type of structure that allows electromigration, then the interconnects are strongly connected, and the combined length of both interconnects must be compared with a single Blech length to determine if the interconnects are susceptible to failure from electromigration. It should be noted that other structures in addition to conventional vias, such as the “bamboo” structures discussed above, may also prevent electrically connected portions of a current path from being strongly connected.

Still other features can impact the susceptibility of a current path to electromigration, such as heat treatment of the material in the current path, frequency in variation of the current direction, crystallographic orientation of the grains in the material, etc.

### Electromigration Feature Determination Tool

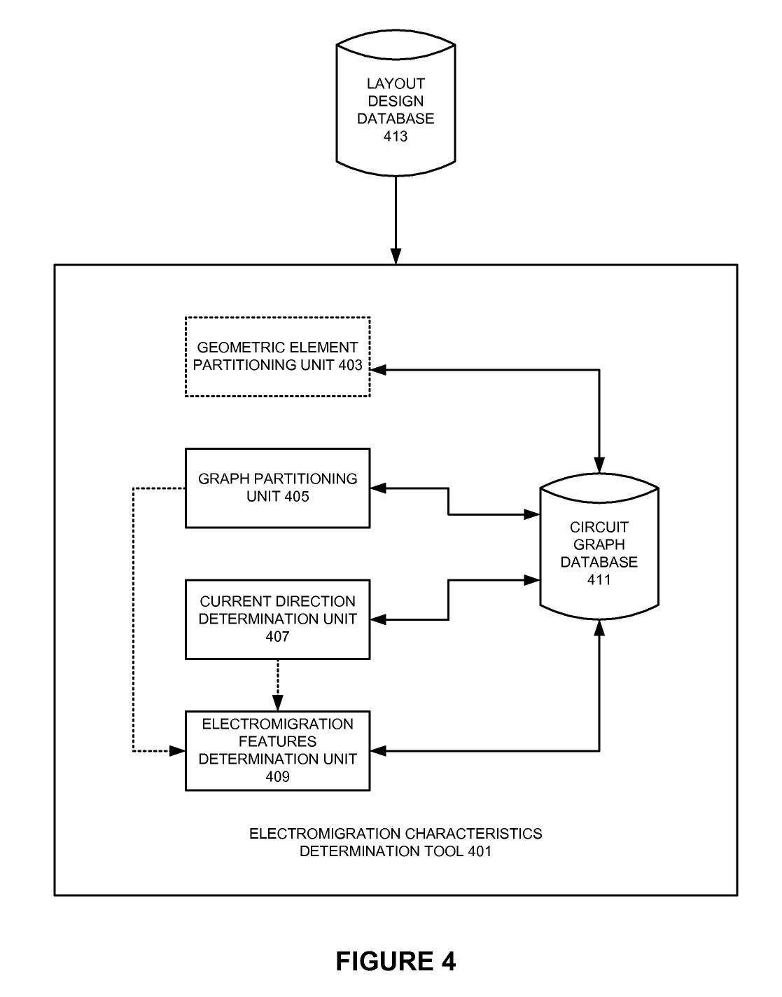

FIG. 4 illustrates an electromigration feature determination tool 401 for determining electromigration features corresponding with layout design data according to various embodiments of the invention. As seen in this figure, the tool 401 includes an optional geometric element partitioning unit 403 and a strongly connected portion partitioning unit 405. The tool 401 also includes a current direction determination unit 407, an electromigration features determination unit 409 and a circuit graph database 411. As seen in this figure, the electromigration features determination tool 401 may work with layout design data obtained from a layout design database 413.

As previously noted, various examples of the invention may be implemented by a multiprocessor computing system, such as the multiprocessor computing system 101 illustrated in FIG. 1. Accordingly, one or more components of each of the geometric element partitioning unit 403, the strongly connected portion partitioning unit 405, the current direction determination unit 407, and the electromigration features determination unit 409 may be implemented by one or more processors in a multiprocessor computing system's master computer, such as the master computer 103, one or more servant computers in a multiprocessor computing system, such as the servant computers 117, or some combination of both executing the appropriate software instructions. Of course, still other embodiments of the invention may be implemented by, for example, one or more computer-readable storage devices having such software instructions stored thereon in a non-transitory manner, i.e., stored by a device over a period of time such that they may be retrieved at a single location in space for use at any arbitrary point during that period of time.

It also should be appreciated that, while the geometric element partitioning unit 403, the strongly connected portion partitioning unit 405, the current direction determination unit 407, and the electromigration features determination unit 409 are shown as separate units in FIG. 4, a single servant computer (or a single processor within a master computer) may be used to implement two or more of these units at different times, or components of two or more of these units at different times.

With various examples of the invention, the circuit graph database 411 and the layout design database 413 may be implemented using any suitable computer readable storage device. That is, either of the circuit graph database 411 and the layout design database 413 may be implemented using any combination of computer readable storage devices including, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable storage devices may also include magnetic cassettes, magnetic tapes, magnetic disks or other magnetic storage devices, punched media, holographic storage devices, or any other non-transitory storage medium that can be used to store desired information.

As will be discussed in more detail below, the geometric element partitioning unit 403 obtains layout design data from the layout design database 413, and partitions geometric elements in the layout design data into portions. These geometric element portions are stored as a graph, such as an undirected cyclic graph, in the circuit graph database 411. The graph partitioning unit 405 partitions the nodes of the graph into subgraphs, such that the nodes of each strongly connected geometric element or group of elements are categorized into a single corresponding subgraph. The current direction determination unit 407 then analyzes the geometric element portions to determine an expected current direction between adjacent geometric element portions. Further, the current direction determination unit 407 uses these expected current directions to update the circuit graph in the circuit graph database 411, converting the circuit graph from an undirected cyclic graph to a directed acyclic graph.

Once a directed acyclic graph describing the geometric elements has been created, the electromigration features determination unit 409 can employ the information from the graph to determine the electromigration features associated with the geometric element or elements for each subgraph. For example, the electromigration features determination unit 409 can determine the expected current paths for a strongly connected geometric element or elements from the corresponding directed acyclic subgraph describing the portions of the strongly connected geometric element or elements. Using physical characteristics represented by the geometric element portions (typically provided by the geometric element partitioning unit 403 as well), the electromigration features determination unit 409 can then identify the length of the longest current path through those geometric element portions. If this length does exceed the Blech length for the geometric elements, then the electromigration features determination unit 409 can provide an indication that a circuit structure manufactured from the strongly connected geometric element or elements will be susceptible to electromigration.

### Determination of Electromigration Features

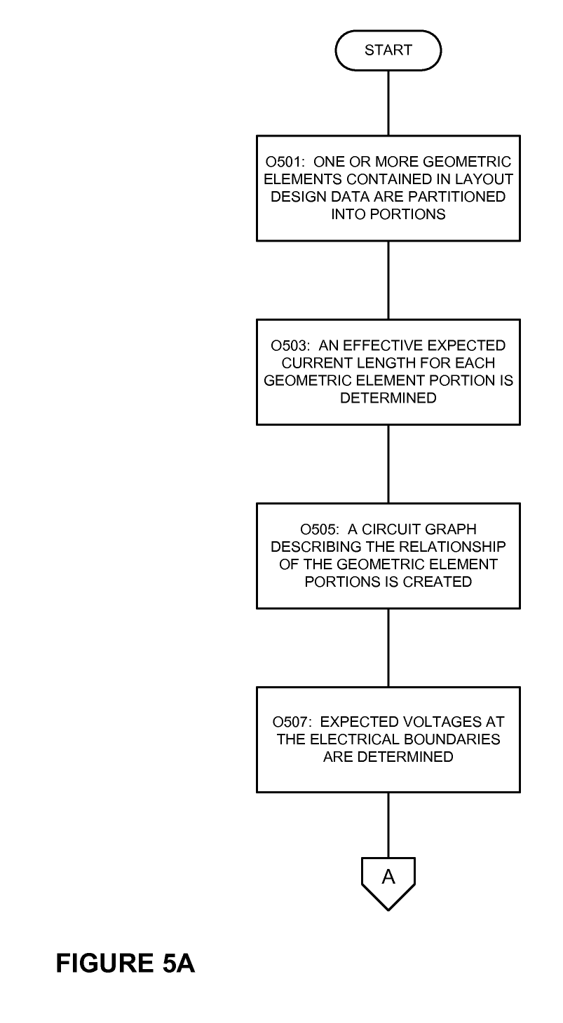

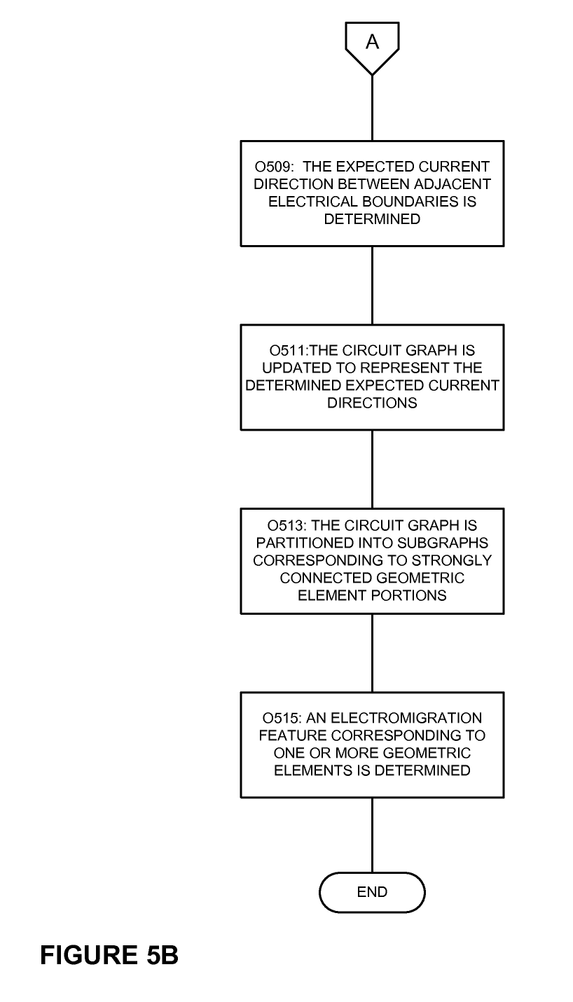

FIGS. 5A and 5B illustrate a flowchart showing a process for determining electromigration features corresponding to layout design data that may be implemented according to various examples of the invention. While different aspects of this process will be described with reference to the electromigration feature determination tool 401 shown in FIG. 4, it should be appreciated that various methods for determining electromigration features corresponding to layout design data according to the present invention may be implemented without using the specific electromigration feature determination tool 401 shown in FIG. 4. Similarly, the electromigration feature determination tool 401 may be used to implement alternate methods for determining electromigration features corresponding to layout design data according to the present invention.

In operation 501, the geometric element partitioning unit 403 partitions one or more geometric elements contained in layout design data into portions. The geometric element or elements may be obtained, for example, from a separate database of layout design data, such as the layout design database 413. Typically, each geometric element will be a polygon having a “Manhattan” shape (that is, having only right angles, which can be convex or concave). Typically, the geometric element partitioning unit 403 will be used to partition a large amount of layout design data, such as the data comprising a design for an integrated circuit or a portion of an integrated circuit. Alternately, the geometric element partitioning unit 403 may be used to partition a smaller amount of layout design data of particular interest. For example, the geometric element or elements partitioned by the geometric element partitioning unit 403 may describe the electrical structures forming only a single net in a circuit (that is, the geometric element or elements describing the interconnects connecting input/outputs of multiple electrical devices together), or even a single geometric element.

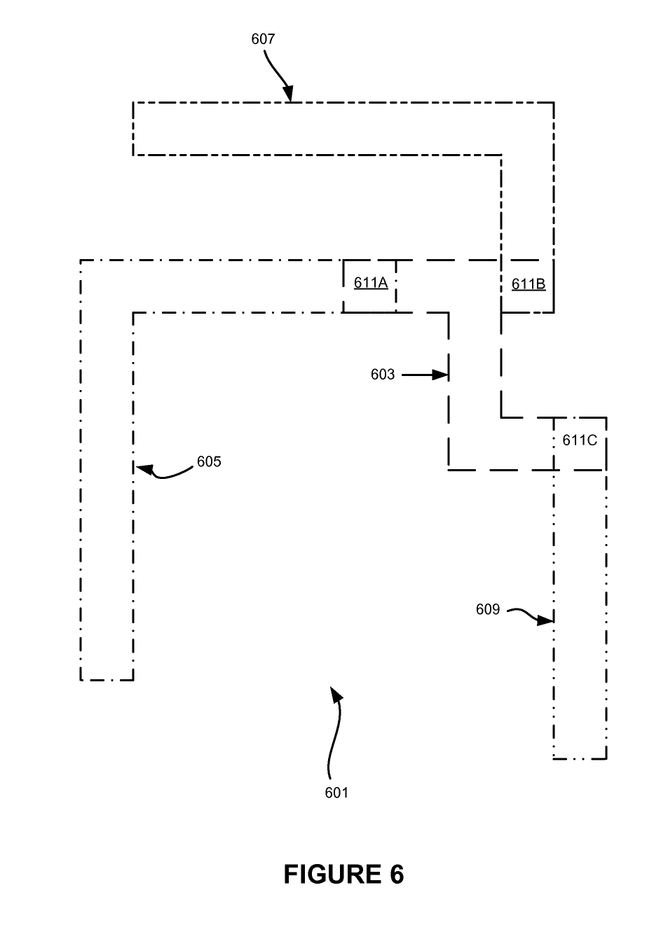

FIG. 6 illustrates an example of a net 601 for partitioning by the geometric element partitioning unit 403. The net 601 is made up of a geometric element 603 on a first metal layer, a geometric element 605 on a second metal layer, a geometric element 607 on a third metal layer, and a geometric element 609 on a fourth metal layer. The geometric element 603 is connected to the geometric element 605 through a via 611A, and is connected to the geometric element 607 through a via 611B. The geometric element 603 also is connected to the geometric element 609 through a via 611C.

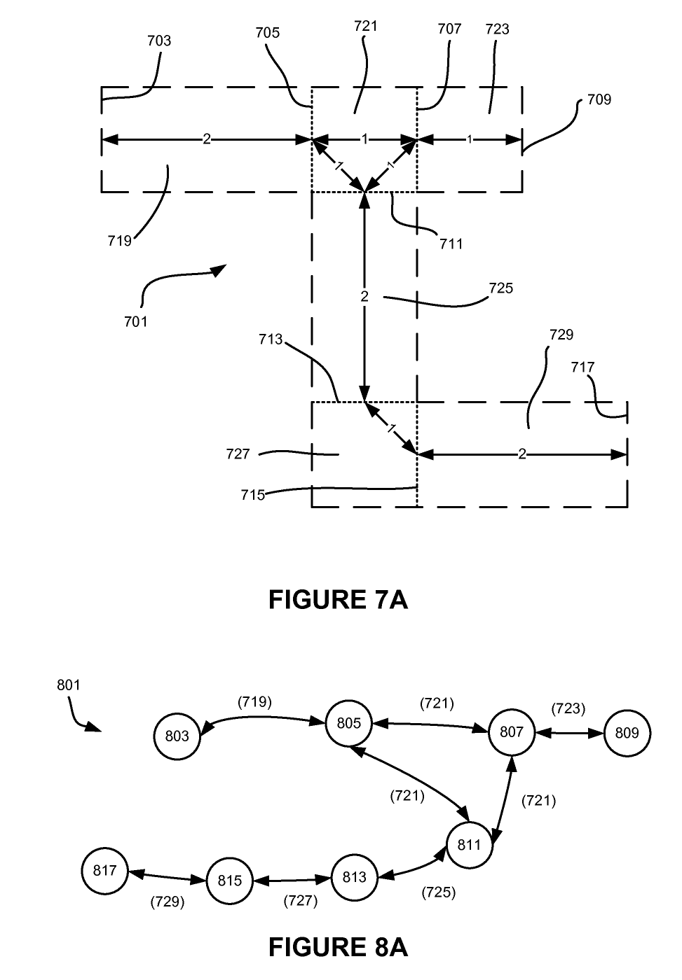

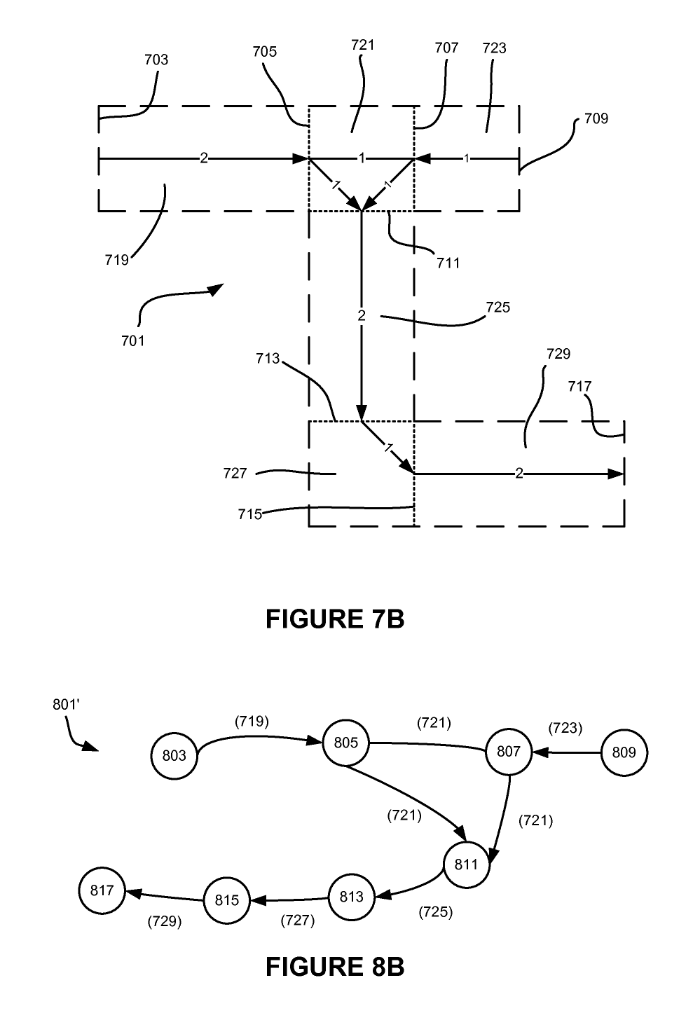

With various implementations of the invention, the geometric element partitioning unit 403 partitions each geometric element into rectangles, typically according to changes in the perimeter of a geometric element. With some implementations of the invention, for example, the geometric element partitioning unit 403 may form square portions between opposing convex and concave angles, with the remainder of a geometric element being rectangles. FIG. 7A illustrates one example of how the geometric element 603 may be partitioned at partition boundaries 703-717, forming six geometric element portions 719-729. As seen in this figure, the partition boundaries 703, 709, and 717 are terminal partition boundaries defined by the connection of the geometric element 603 to the vias 611A-611C, respectively. The partition boundaries 705, 7078, 711, 713 and 715 then are internal partition boundaries created at changes in the perimeter of the geometric element 603.

In step 503, the geometric element partitioning unit 403 determines an effective expected current length for each geometric element portion. As used herein, the effective expected current length for a geometric element portion refers to the length an expected current would travel through a circuit structure manufactured from that geometric element portion. According to various embodiments of the invention, the effective expected current length for a geometric element portion may be measured from one partition boundary to another partition boundary.

For example, FIG. 7A shows that the geometric element portion 719 has an effective expected current length of 2 units, as measured from partition boundary 703 to the partition boundary 705. (As used herein, the term unit may be any desired measurement of length, such as a micron.) The geometric element portion 731 then has an effective expected current length of 1 unit, as measured from the partition boundary 707 to the partition boundary 709. As will be appreciated by those of ordinary skill in the art, a geometric element portion may have more than one effective expected current length, depending upon the number of directions through which current would be expected to flow through a circuit structure manufactured from that geometric element portion. For example, FIG. 7A shows the geometric element portion 721 having a first effective expected current length extending from the partition boundary 705 to the partition boundary 707. But it also shows the geometric element portion 721 having a second effective expected current length extending from the partition boundary 705 to the partition boundary 711. The geometric element portion 703 also has a third effective expected current length extending from the partition boundary 707 to the partition boundary 711. In this figure, all three of the illustrated effective expected current lengths for geometric element portion 721 are shown with a value of 1 unit for ease of explanation, but it will be appreciated that the effective expected current lengths can be calculated more precisely according to various examples of the invention. In FIG. 7A, the expected current lengths are shown using bidirectional arrows, as the directions of the expected currents through the geometric element portions have not yet been ascertained.

In addition to the effective expected current lengths, the geometric element partitioning unit 403 may extract additional physical characteristic information described by or otherwise corresponding to the geometric element portions. For example, the geometric element partitioning unit 403 may extract the width of each geometric element portion (i.e., the width of the portion in a direction orthogonal to the effective expected current length), the material for a circuit structure manufactured from the geometric element portion, heat treatment to be applied to the material, expected crystallographic orientation of the grains in the material, frequency in variation of the direction of the expected current, or any other information described by or otherwise corresponding to the geometric element portions that would be useful in determining the susceptibility of circuit structures manufactured from the geometric element portions to failure from electromigration.

Next, in operation 505, the geometric element partitioning unit 403 creates a circuit graph describing the relationship of the geometric element portions. For example, FIG. 8A illustrates a circuit graph 801 describing the relationship between the geometric element portions 719-729 shown in FIG. 7A. As seen in this figure, each partition boundary 703-717 is represented in the graph 801 by a corresponding node 803-817, respectively. Edges are placed connecting nodes such that the edges represent the geometric element portions between the corresponding electrical boundaries. Accordingly, graph 801 has, for example, an edge between node 803 and node 805 corresponding to the geometric element portion 719, and another edge between node 811 and node 813 corresponding to the geometric element portion 725. In the illustrated example, the edges are graphically shown using bidirectional arrows, as the directions of the expected currents through the geometric element portions have not yet been ascertained. In the actual graph 801, these edges may likewise be used to identify the current direction between the partition boundaries using, for example, pairs of bidirectional links between nodes or similar data structures. As a result, the graph 801 shown in FIG. 8A is an undirected cyclic graph. As previously noted, the graph 801 may be stored in the circuit graph database 411.

With various examples of the invention, the circuit graph may also include information relating the represented geometric element portions. For example, the edge between node 803 and node 805, corresponding to geometric element portion 719, may include data indicating the length of the geometric element portion between partition boundary 703 and partition boundary 705. The edge may also include, e.g., the width of the geometric element portion 719, the material from which the geometric element portion structure will be manufactured, heat treatment of that material, frequency in variation of the current direction through the geometric element portion structure, crystallographic orientation of the grains in the material, etc.

It should be appreciated that, while operations 501-503 are described as being performed in sequence, with various implementations of the invention two or more of these operations may be performed in parallel. For example, with some embodiments of the invention, the geometric element partitioning unit 403 may be extracting physical data from a first geometric element while adding a node to a circuit graph corresponding to a second geometric element portion and creating a partition boundary to define a third geometric element portion.

Similarly, with various implementations of the invention, all of the geometric elements in the layout design data (in the above example, geometric elements 605-609) may be partitioned together, either sequentially or in parallel using a parallel computer system, such as the computing system 101 illustrated in FIG. 1. For example, with some implementations of the invention, some geometric elements in the layout design data may be partitioned while the geometric element partitioning unit 403 begins to extract physical characteristics information for portions of other geometric element, etc.

With various examples of the invention, some or all of the geometric element partitioning unit 403 may be implemented by an electronic design automation parasitic extraction tool for extracting parasitic information from layout design data. Likewise, some or all of the operations 501-503 may be performed using an electronic design automation parasitic extraction tool for extracting parasitic information from layout design data. An example of such an electronic design automation parasitic extraction tool is the Calibre© xRC™ parasitic extraction tool available from Mentor Graphics® Corporation of Wilsonville, Oreg. Also, while the geometric element partitioning unit 403 has been described with respect to the electromigration feature determination tool 401, it should be appreciated that some or all of the geometric element partitioning unit 403 may be optionally omitted from the electromigration feature determination tool 401. For example, with some implementations of the invention, the geometric element partitioning unit 403 may receive geometric elements that have already been partitioned by an earlier EDA process performed by an entity different from the entity implementing a method according to the invention. With these implementations, the geometric element partitioning unit 403 may simply create the graph data based upon the previously-partitioned geometric elements. With still other implementations of the inventions, the geometric element partitioning unit 403 may be omitted entirely, and the electromigration feature determination tool 401 may receive existing graph data from an be provided directly from an earlier EDA process performed by an entity different from the entity implementing a method according to the invention.

In operation 507, the current direction determination unit 407 determines expected voltage changes between partition boundaries. For example, with some embodiments of the invention, the current direction determination unit 407 may implement or otherwise employ a matrix solver to determine the expected voltage drops between partition boundaries given a specified input applied to a circuit structure manufactured from the geometric element or elements. Examples of matrix solvers that may be employed according to various examples of the invention include the SPICE matrix solvers, the KLU matrix solver designed by Timothy Davis at the University of Florida, and variations of these matrix solvers. (In this context, the term SPICE refers to all of the circuit simulators that are based on the same algorithms of the original UC Berkeley SPICE simulator.) The use and operation of these matrix solvers are well known in the art, and thus will not be discussed in further detail herein. Also, sources for these matrix solvers are well known (SPICE, for example, is a well-known open source product easily obtained via the Internet), and thus also will not be discussed herein in detail.

As will be appreciated by those of ordinary skill in the art, these matrix solvers are commonly employed as electronic design automation tools to determine the voltage values that would be expected at different nets in a circuit design in response to a given circuit input. With the examples of the invention, however, rather than identifying the expected voltage at each net in a circuit design, the matrix solver is used to determine the voltage that would be expected at the partition boundaries for each geometric element portion in response to the application of a given stimulus to the circuit structures represented by the geometric element or elements. With various implementations of the invention, the expected voltages can be stored in the circuit graph database 411 with the circuit graph. The expected voltages may be stored, for example, as data attached to or otherwise associated with the corresponding nodes in the circuit graphs.

Next, in operation 509, the current direction determination unit 407 determines the expected current directions through each geometric element portion based upon the expected voltage changes. More particularly, if the expected voltage change from a partition boundary on a first side of a geometric element portion to a partition boundary on a second side of the geometric element portion is a drop (e.g., the voltage change is −1 Volt), then the expected current direction is from the first side of the geometric element portion to the second side of the geometric element portion. As previously noted, the term current direction as used herein refers to the conventional current direction, that is, the flow of positive charges through a geometric element portion. The flow of electrons therefore will be in the opposite direction of the expected current direction.

For example, FIG. 7B illustrates the determined expected current directions for the geometric element portions 719-729. As seen in this figure, for example, the direction of current in the geometric element portion 719 is from partition boundary 703 to partition boundary 705. Also, the direction of current in the geometric element portion 723 is from partition boundary 709 to partition boundary 707, while the direction of current in the geometric element portion 725 is from partition boundary 711 to partition boundary 713. (It should be appreciated that, while a current direction between partition boundary 705 and partition boundary 707 can be determined, this current is probably negligible in the illustrated example, and thus is not shown.)

Next, in operation 511, the circuit graph is updated to represent the determined expected current directions. For example, as shown in FIG. 8B, the edges of the circuit graph 801′ are updated to reflect the expected current directions through their corresponding geometric element portions. Accordingly, the edge between node 803 (corresponding to partition boundary 703) and node 805 (corresponding to partition boundary 705) is given a direction pointing from node 803 to node 805 representing the expected current direction through the geometric element portion 719. In this manner, the circuit graph is converted from an undirected cyclic graph to a directed acyclic graph.

In operation 513, the graph partitioning unit 405 partitions the circuit graph into subgraphs corresponding to strongly connected geometric element portions. More particularly, the circuit graph typically will represent all of the geometric element portions in the layout design data. For example, with the layout design data shown in FIG. 6, the circuit graph will represent the geometric element portions 719-729 making up the geometric element 603. The circuit graph will also represent the geometric element portions making up each of the geometric element 605-609. In operation 513, the graph partitioning unit 405 determines that the geometric element portions 719-729 making up the geometric element 603 are strongly connected, and thus identifies the corresponding nodes 803-817 in the circuit graph as a distinct subgraph. (Thus, with various implementations of the invention, the graphs 801 and 801′ will actually be subgraphs of a larger circuit graph). Similarly, the graph partitioning unit 405 determines that the geometric element portions making up the geometric element 605 are strongly connected, and identifies the nodes corresponding to these geometric element portions as a distinct subgraph within the circuit graph. The graph partitioning unit 405 also will identify a third subgraph made up of the nodes corresponding to the geometric elements portions of geometric element 607, and a fourth subgraph made up of the nodes corresponding to the geometric elements portions of geometric element 607.

With various implementations of the invention, the graph partitioning unit 405 may identify subgraphs based upon rule-based heuristics, user designated information, or some combination of both to determine which geometric elements are closely connected (or treated as such). For example, the graph partitioning unit 405 may determine that only those geometric elements portions making up a single geometric element should be used to define a subgraph of the larger circuit graph. Alternately, the graph partitioning unit 405 may determine that the geometric elements portions making up a one or more connected geometric elements for a single layer of material (i.e., not connected with a via) should be used to define a subgraph of the larger circuit graph. Alternately or additionally, the graph partitioning unit 405 may recognize user-added markers in the layout data to determine how corresponding subgraphs should be defined in the larger circuit graph.

It should be appreciated that, while the graph partitioning operation 513 is illustrated as being subsequent to operations 507-511, the graph partitioning operation can be performed at any time. For example, the circuit graph may be partitioned into subgraphs before any of operations 507-511, or in parallel with any of these operations. Still further, the process for identifying the subgraphs may be initiated even before the geometric elements are partitioned. For example, with some implementations of the invention, an precursor graph may be created where, e.g., each node of the precursor graph represents a single geometric element in the layout design data. As each geometric element in the layout design data is partitioned, each corresponding node in the precursor graph will be replaced with the nodes representing the partition boundaries partitioning that geometric element. With these implementations of the invention, the graph partitioning unit 405 may designate that all partition boundary nodes replacing a single node in the precursor graph be identified as a subgraph of the circuit graph.

In operation 515, the electromigration features determination unit 409 determines an electromigration feature corresponding to the geometric element portions of one or more geometric elements. More particularly, the electromigration features determination unit 409 will traverse a subgraph of the circuit graph to determine one or more electromigration feature corresponding to the geometric element portions represented by that subgraph.

For example, with the geometric element portions 719-729, the electromigration features determination unit 409 may traverse the directed acyclic graph 801′ (which, as explained above, may be a subgraph of a larger circuit graph) according to the specified directions to determine the longest path in the graph 801′. As will be appreciated by those of ordinary skill in the art, this path will represent the longest current path through the geometric element 603. Once this longest current path is determined, it can, for example, be compared with the Blech length for the material from which the geometric element structure will be formed, to determine if that geometric element will be susceptible to electromigration effects. Of course, still other electromigration effect features may be alternately or additionally be determined by the electromigration features determination unit 409. For example, in addition to the longest current path length through one or more geometric elements, the electromigration features determination unit 409 may determine the length of any current path through one or more geometric elements, which can then be compared with the appropriate Blech length. Still further, by including other layout design information in the circuit graph such as, the material in the structure forming a current path, heat treatment of the material in the current path, frequency in variation of the current direction, crystallographic orientation of the grains in the material, etc, the electromigration features determination unit 409 may take into account this information to determine electromigration features of an expected current path for one or more geometric elements.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

What is claimed is:

1. A method of determining electromigration features corresponding to one or more geometric elements in layout design data, comprising:
for one or more geometric elements partitioned into portions, employing a computer to determine expected current directions through the geometric element portions;
based upon the determined current directions, employing a computer to identify an expected current path through the geometric element portions; and
employing a computer to determine electromigration features corresponding to the one or more geometric elements based upon at least one physical characteristic represented by the geometric element portions in the expected current path.

2. The method recited in claim 1, wherein the at least one physical characteristic is selected from the group consisting of: portion width, portion length, and represented material.

3. The method recited in claim 2, wherein
the at least one physical characteristic includes portion length, and
the electromigration features corresponding to the one or more geometric elements is the Bletch length.
